(19) United States
(12) Patent Application Publication
(10) Pub. No.: US 2012/0260957 A1
(43) Pub. Date: Oct. 18, 2012

(54) Automatic Washer

(75) Inventor: Ji-In Lee, Gyeonggi-do (KR)

(73) Assignee: UNICO CYBERCOM CORP., Seoul (KR)

(21) Appl. No.: 13/084,740

(22) Filed: Apr. 12, 2011

(51) Int. Cl. B08B 3/00

(52) U.S. Cl. 134/56 R

(57) ABSTRACT

An automatic washer is provided. The automatic washer includes a washer body having a receiving groove, a washing container rotatably disposed in the receiving groove to contain vegetables or fruits therein, a washing container rotation module disposed on the washer body to rotate the washing container, a water supply and discharge module disposed on the washer body to control supply and discharge of washing water, a control module disposed on the washer body to control operations of the washing container rotation module and the water supply and discharge module, a cover openably disposed on the washer body, the cover including a rib on an inner surface thereof, and a power supply module supplying a power into the washing container rotation module and the water supply and discharge module.

### FIELD OF THE INVENTION

The present invention relates to an automatic washer, and more particularly, to an automatic washer which quickly and cleanly washes and sterilizes vegetables or fruits.

### BACKGROUND OF THE INVENTION

In general, various agricultural chemicals and fertilizers are sprayed onto fruits such as apple, pear, mandarin, etc, and vegetables such as lettuce, parsley, spinach, etc, during cultivation to prevent occurrence of disease and insects and promote growth. Thus, when the fruits and the vegetables are harvested, the agricultural chemicals or fertilizers may partially remain on surfaces of the fruits and vegetables.

Also, when the fruits or vegetables are cultivated, various parasites are inhabited. As a result, the fruits or vegetables may be harvested in a state where the various parasites or eggs of the parasites remain on the surfaces of the fruits or vegetables. Thus, harmful components such as the agricultural chemicals or fertilizers, the parasites, or the eggs must be removed before eating the fruits or vegetables. If not, human body may be damaged.

The fruits or vegetables were manually washed in the past. However, since a quantity of fruits or vegetables to be washed is many in large-scale restaurants or cafeterias, a great many people and a great deal of time are required for washing the fruits or vegetables, thereby increasing costs.

### SUMMARY OF THE INVENTION

Accordingly, the present invention is directed to an automatic washer that substantially obviates one or more problems due to limitations and disadvantages of the related art.

An object of the present invention is to provide an automatic washer in which a large amount of vegetables or fruits quickly may be washed to save people and time required for washing, agricultural chemicals remaining on the vegetables or fruits are effectively removed using ozone, the germs, microorganisms, or parasites are sterilized using a sterilization lamp, and a deodorization tube communicating with a discharge part cover is disposed in a washer body and an exhaust fan is disposed within the deodorization tube to quickly discharge ozone small and bad small generated during the washing.

According to an aspect of the present invention, there is provided an automatic washer including: a washer body having a receiving groove; a washing container rotatably disposed in the receiving groove to contain vegetables or fruits therein; a washing container rotation module disposed on the washer body to rotate the washing container; a water supply and discharge module disposed on the washer body to control supply and discharge of washing water; a control module disposed on the washer body to control operations of the washing container rotation module and the water supply and discharge module; a cover openably disposed on the washer body, the cover including a rib on an inner surface thereof; and a power supply module supplying a power into the washing container rotation module and the water supply and discharge module.

The washing container rotation module may include: a driving motor generating a power; a rotation shaft passing through a center of a bottom of the receiving groove of the washer body and coupled to the driving motor; and a coupling coupled to the rotation shaft and engaged with a bottom surface of the washing container.

An insertion groove in which the coupling may be inserted is defined in the bottom surface of the washing container, a plurality of fixing protrusions spaced a predetermined distance from each other may be disposed on an outer circumference surface of the coupling, and hook protrusions respectively inserted between the fixing protrusions may be disposed on an inner surface of the insertion groove.

Each of the fixing protrusions and each of the hook protrusions may have inclined surfaces.

The water supply and discharge module may include: a water supply and discharge pump disposed on a lower portion of the washer body to supply or discharge the washing water; a water supply valve connected to the water supply and discharge pump to control the water supply; and a water discharge valve connected to the water supply and discharge pump to control the water discharge.

The automatic washer may further include an ozone supply module generating ozone, the ozone supply module being disposed at a lower portion of the washer body to supply the ozone into the receiving groove.

The ozone supply module may include: an ozone generator generating the ozone by the control module; an ozone pipe connecting the ozone generator to an ozone discharge hole defined in the bottom of the receiving groove; and an ozone pump pumping the ozone generated in the ozone generator.

An ozone discharge part having a cylindrical shape and a first ozone discharge hole for discharging ozone within the receiving groove to the outside may be disposed on a central portion of the cover, a deodorization filter for filtering ozone small may be disposed within the ozone discharge part, and a discharge part cover having a second ozone discharge hole may be coupled to a lower portion of the ozone discharge part.

A deodorization tube communicating with the discharge part cover may be disposed in the washer body, and an exhaust fan may be disposed within the deodorization tube.

The rib may allow water drops scattered during the rotation of the washing container to drop into the washing container after the water drops are collided against an under surface of the cover, but do not flow along a wall of the receiving groove.

The automatic washer may further include a sterilization lamp disposed on a sidewall of the washer body to radiate light into the washing container, thereby sterilizing an object to be washed within the washing container.

The washing container may include a vegetable and fruit washing container for washing the vegetables and fruits and a rice washing container for washing rice, the vegetable and fruit washing container and the rice washing container may have a plurality of fine holes in bottom surfaces and side surfaces thereof to smoothly discharge the washing water, and a wire net may be disposed on an edge of an upper portion of the rice washing container.

The cover may be elastically opened or closed by a torsion spring (not shown) disposed on a hinge of the washer body, a locking protrusion of the cover may be locked into a locking groove of the cover, and a rocking release button for releasing the locking of the locking protrusion may be disposed on the washer body.

The automatic washer may further include: a circular-shaped body in which water rolling-down inclined parts protruding upward with a predetermined distance are disposed on an outer portion thereof, a water recovery hole for recovering the water remaining on an outer side surface of the cover into the receiving groove is disposed between the water rolling-down inclined parts, an edge part protrudes upward from an outer circumference thereof, and the seal ring groove is disposed on the edge part; and a seal ring inserted into a seal ring groove.

The body may have a top surface inclined toward the water recovery hole.

A hook part hooked to the washer body may be disposed on each of both sides of the edge part of the body.

The body may be disposed directly above the washing container to prevent the washing water from being spattered upward during a washing process.

### BRIEF DESCRIPTION OF THE DRAWINGS

FIG. 1 is an exploded perspective view of an automatic washer according to an embodiment of the present invention.

FIG. 2 is a front perspective view of an automatic washer according to an embodiment of the present invention.

FIG. 3 is a rear perspective view of an automatic washer according to an embodiment of the present invention.

FIG. 4 is a plan view of an automatic washer according to an embodiment of the present invention.

FIG. 5 is a sectional view of an automatic washer according to an embodiment of the present invention.

FIG. 6 is a view of an automatic washer according to an embodiment of the present invention.

FIG. 7 is a bottom view of a fruit and vegetable washing container according to an embodiment of the present invention.

FIG. 8 is a perspective view of rice washing container according to an embodiment of the present invention.

FIG. 9 is a perspective view of a water recovery cover according to an embodiment of the present invention.

FIG. 10 is a side view of FIG. 9.

FIG. 11 is a plan view of FIG. 9.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, an automatic washer according to an embodiment of the present invention will be described in detail with reference to the accompanying drawings.

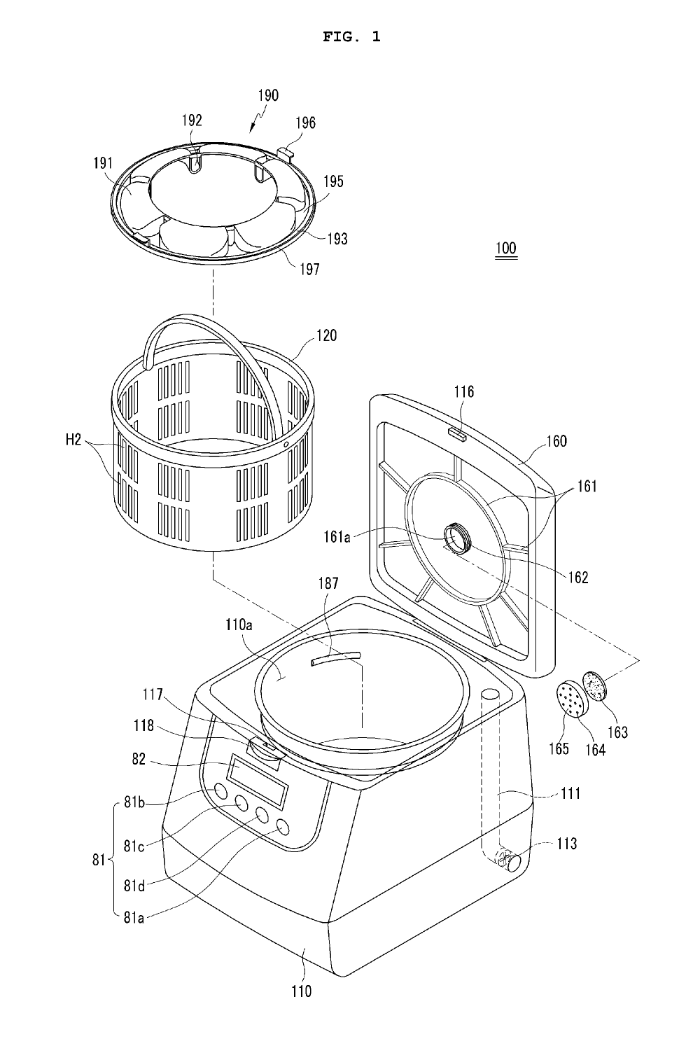

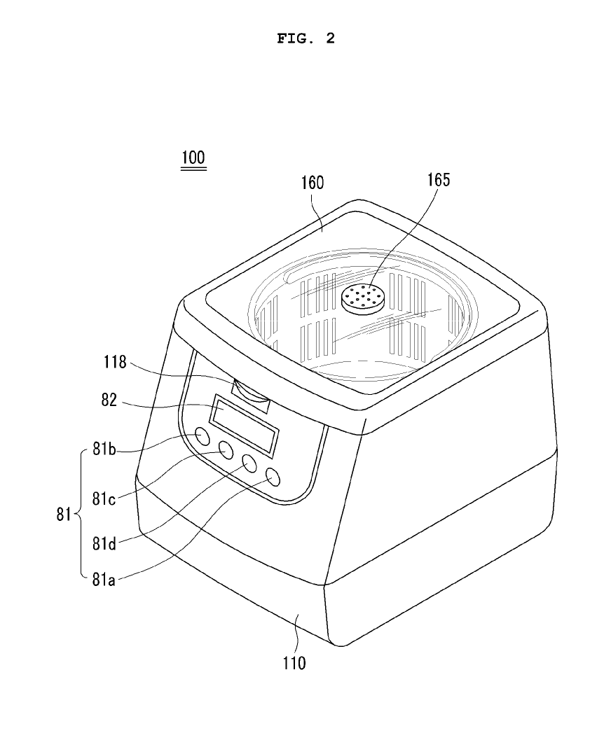

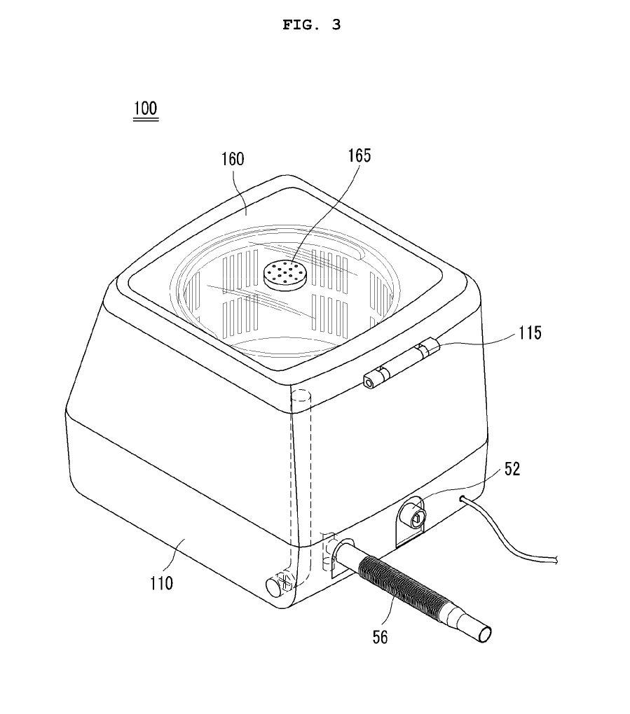

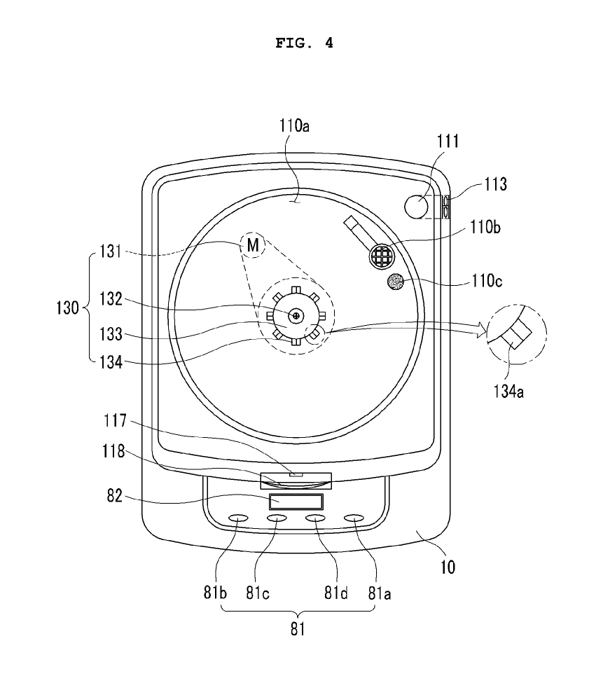

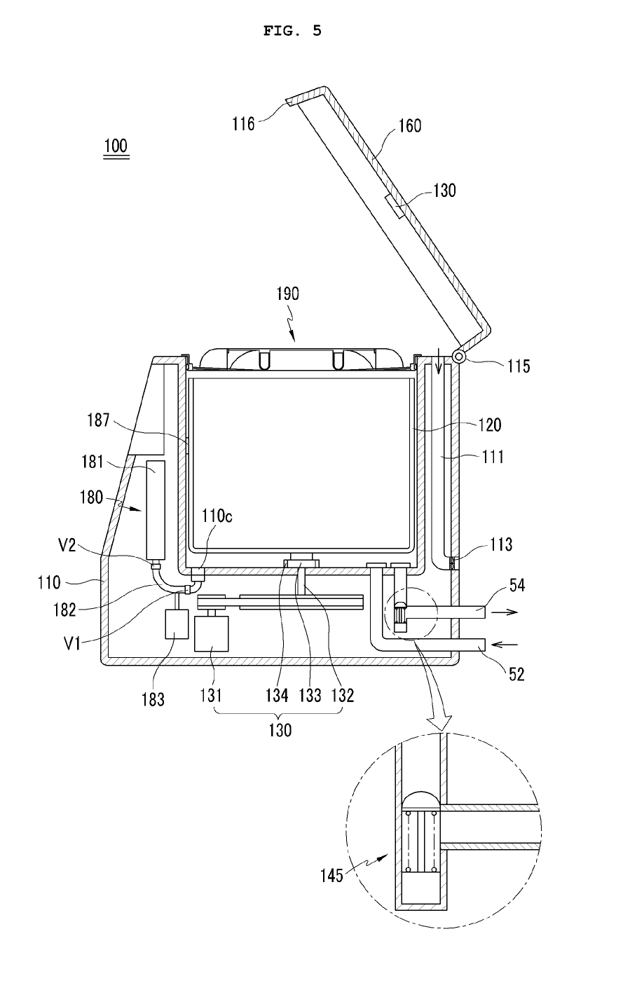

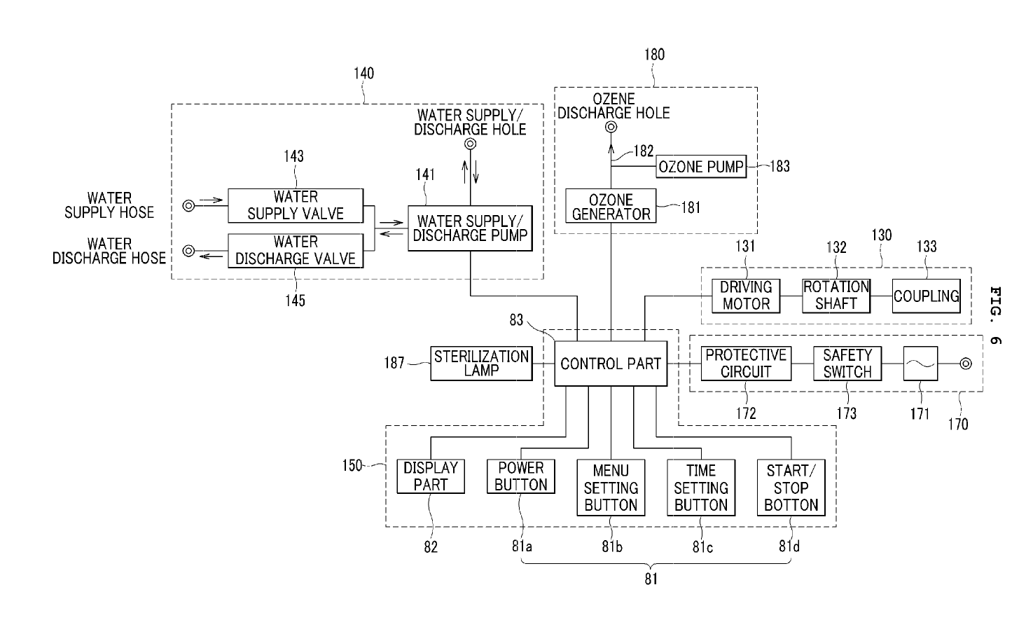

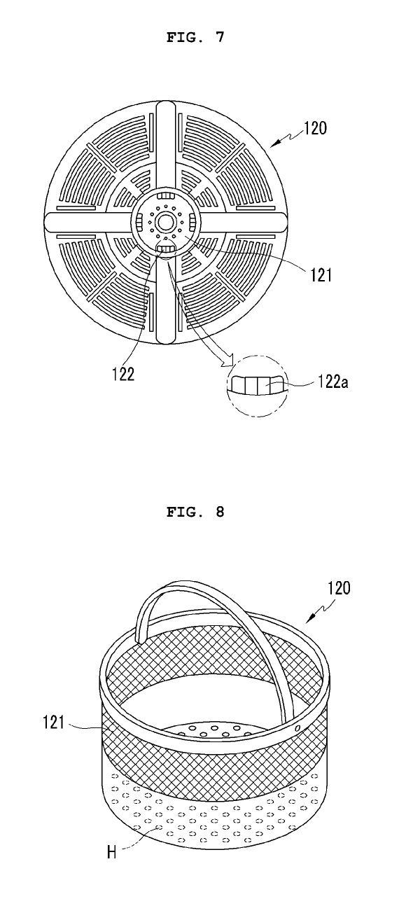

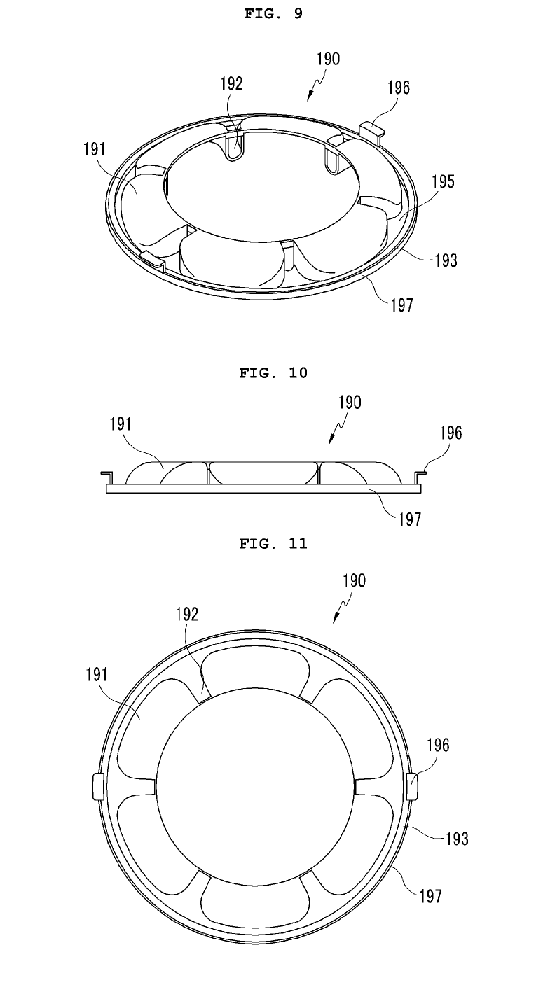

FIG. 1 is an exploded perspective view of an automatic washer according to an embodiment of the present invention, and FIG. 2 is a front perspective view of an automatic washer according to an embodiment of the present invention. FIG. 3 is a rear perspective view of an automatic washer according to an embodiment of the present invention, and FIG. 4 is a plan view of an automatic washer according to an embodiment of the present invention. FIG. 5 is a sectional view of an automatic washer according to an embodiment of the present invention, and FIG. 6 is a view of an automatic washer according to an embodiment of the present invention. FIG. 7 is a bottom view of a fruit and vegetable washing container according to an embodiment of the present invention, and FIG. 8 is a perspective view of rice washing container according to an embodiment of the present invention.

Referring to FIGS. 1 to 8, an automatic washer 100 according to an embodiment of the present invention includes a washer body 110 having a receiving groove 110a, a washing container 120 rotatably disposed in the receiving groove 110a to contain vegetables or fruits therein, a washing container rotation module 130 disposed on the washer body 110 to rotate the washing container 120, a water supply and discharge module 140 disposed on the washer body 110 to control water supply and discharge, a control module 150 disposed on the washer body 110 to control operations of the washing container rotation module 130 and the water supply and discharge module 140, a cover 160 openably disposed on the washer body 110 and including a rib 161 on an inner surface thereof, a power supply module 170 supplying a power into the washing container rotation module 130 and the water supply and discharge module 140, and an ozone supply module 180 disposed at a lower portion of the washer body 110 and generating ozone to supply the ozone into the receiving groove 110a.

As shown in FIG. 4, a water supply and discharge hole 110b for supplying or discharging washing water and an ozone discharge hole 110c for discharging the ozone are defined in a bottom of the receiving groove 110a of the washer body 110.

The washing container rotation module 130 includes a driving motor 131 for generating a power, a rotation shaft 132 passing through a center of the bottom of the receiving groove 110a of the washer body 110 and coupled to the driving motor 131, and a coupling 133 coupled to the rotation shaft 132 and engaged with a bottom surface of the washing container 120.

An insertion groove 121 in which the coupling 133 is inserted is defined in the bottom surface of the washing container 120. Also, a plurality of fixing protrusions 134 spaced a predetermined distance from each other are disposed on an outer circumference surface of the coupling 133. Hook protrusions 122 respectively inserted between the fixing protrusions 134 are disposed on an inner surface of the insertion groove 121 (refer to FIGS. 4 and 7).

Inclined surfaces 134a and 122a are disposed on each of the fixing protrusions 134 and each of the hook protrusions 122, respectively (refer to FIGS. 4 and 7).

The water supply and discharge module 140 includes a water supply and discharge pump 141 disposed on a lower portion of the washer body 110 to supply or discharge the washing water, a water supply valve 143 connected to the water supply and discharge pump 141 to control the water supply, and a water discharge valve 145 connected to the water supply and discharge pump 141 to control the water discharge. Here, the water discharge valve 145 may include a release valve (refer to FIG. 5).

When the water supply and discharge pump 141 is forwardly operated in a state where only the water supply valve is opened, the washing water is supplied into the receiving groove 110a. When the water supply and discharge pump 141 is reversely operated in a state where only the water discharge valve 145 is opened, the washing water within the receiving groove 110a is discharged to the outside.

The control module 150 automatically controls operations of the washing container rotation module 130, a water supply and discharge module 140, and the ozone supply module 180. The control module 150 includes a button part 81 disposed on the washer body 110 to apply a power and set various menus or time, a display part 82 displaying operation states of various devices, and a control part 83 controlling operation of the various devices according to input signals inputted through the button part 81. The button part 81 includes a power button 81a for turning on/off a power source, a menu setting button for setting a menu, a time setting button 81c for setting a time, a start/stop button 81d for stating and stopping operations of the devices according to the set menu. In the power button 81a, when the power button 81a is pushed one time, the power is turned on. Then, when the power button 81a is pushed again one time, the power is turned off. Also, when the devices are not operated in a state where the power is turned on, the power is automatically turned off. The menu setting button 81b may set various menus by a pushed degree. When vegetables or fruits having a normal exterior are washed, a pushed degree is ‘0’. That is, a basic washing operation may be performed even though the menu setting button 81b is not pushed. When the agricultural chemicals remain in appearance, a pushed degree is ‘1’. Here, washing number and time are increased when compared that a pushed degree is ‘0’. Also, when more agricultural chemicals than the amount of the agricultural chemicals in case of the pushed degree ‘1’ remain, a pushed degree is ‘2’. Here, although the same washing number and time as that of the pushed degree ‘1’ is provided, ozone is additionally provided to melt the agricultural chemicals.

Also, a pushed degree is ‘3’ in case where dishes are washed, and a pushed degree is ‘4’ in case where indoor air is cleaned. That is, in case where the pushed degree is ‘4’, the washing process is not performed, but negative ions are periodically emitted.

Also, when water is removed from the previously washed vegetables or fruits, a pushed degree is ‘5’. Here, the washing process is not performed, but only a dehydration process is performed.

An ozone discharge part 162 having a cylindrical shape and a first ozone discharge hole 161a for discharging ozone within the receiving groove 110a to the outside is disposed on a central portion of the cover 160. A deodorization filter 163 for filtering ozone small is disposed within the ozone discharge part 162. A discharge part cover 165 having a second ozone discharge hole 164 is coupled to a lower portion of the ozone discharge part 162.

A deodorization tube 111 communicating with the discharge part cover 165 is disposed in the washer body 110, and an exhaust fan 113 is disposed within the deodorization tube 111.

The exhaust fan 113 quickly discharges the ozone small and bad small remaining in the washer body 110.

The rib 161 allows water drops scattered during the rotation of the washing container 160 to drop into the washing container 120 after the water drops are collided against an under surface of the cover 160, but do not flow along a wall of the receiving groove 110a.

The automatic washer 100 according to an embodiment of the present invention further includes a sterilization lamp 187 disposed on a sidewall of the washer body 110 to radiate light into the washing container 120, thereby sterilizing objects to be washed within the washing container 120.

The washing container 120 washes the vegetables or fruits in a manner in which the washing water is rotated in one direction by a centrifugation operation generated when the washing container 120 is rotated. Thus, the vegetables or fruits are not damaged at all.

The washing container 120 includes a vegetable and fruit washing container (refer to FIGS. 1 and 7) for washing the vegetables and fruits and a rice washing container (refer to FIG. 8) for washing rice.

The vegetable and fruit washing container and the rice washing container have a plurality of fine holes H2 in bottom surfaces and side surfaces thereof to smoothly discharge the washing water. A wire net 121 is disposed on an edge of an upper portion of the rice washing container 120 (refer to FIG. 8).

The cover 130 is elastically opened or closed by a torsion spring (not shown) disposed on a hinge 115 of the washer body 110. A locking protrusion 116 of the cover 130 is locked into a locking groove 117 of the washer body 110. A rocking release button 118 for releasing the locking of the locking protrusion 116 is disposed on the washer body 110.

The power supply module 170 applies a power to each of the devices. The power supply module 170 includes a fuse 171 for connecting an external power source thereto, a protective circuit 172 for protecting the power supply module 170 from an overvoltage/overcurrent, and a safety switch 173 for interrupting a malfunction power of the washer (refer to FIG. 6).

The ozone supply module 180 includes an ozone generator 181 for generating ozone by the control module 150, an ozone pipe 182 for connecting the ozone generator 181 to the ozone discharge hole 110c defined in the bottom of the receiving groove 110a, and an ozone pump 183 for pumping the ozone generated in the ozone generator 181. A one-way valve V1 formed of a stainless material to endure the ozone may be disposed between the ozone discharge hole 110c and the ozone pipe 182. Also, a one-way valve V2 formed of a silicon material may be disposed between the ozone generator 181 and the ozone pump 183.

The ozone is converted into ozone water after an aeration process is performed through the ozone discharge hole 110c. Thus, when the washing process is performed, a small amount of water may flow into the ozone pipe 182. As a result, the ozone generator may be not smoothly operated. The one-way valve V1 may prevent the small amount of water from flowing into the ozone pipe 182. Also, the one-way valve V2 may be further disposed to prevent the water from reversely flowing even though the one-way valve V1 is broken down. Due to the dual-protection structure described above, the malfunction of the ozone generator may be effectively prevented.

The ozone having a bubble shape and supplied through the ozone supply module 180 accelerates oxidative decomposition of the agricultural chemicals remaining on the vegetables or fruits together with the melting and impact using the water to remove the remaining agricultural chemicals. Also, the ozone sterilizes various germs, microorganisms, or parasites attached to the vegetables or fruits.

The automatic washer 100 according to an embodiment of the present invention includes the water recovery cover 190. The water recovery cover 190 includes a body 195 having a circular shape and a seal ring 197 inserted into a seal ring groove 194. According to the body 195, water rolling-down inclined parts 191 protruding upward with a predetermined distance are disposed on an outer portion thereof, and a water recovery hole 192 for recovering the water remaining on an outer side surface of the cover 160 into the receiving groove 110a is disposed between the water rolling-down inclined parts 191. In addition, an edge part 193 protrudes upward from an outer circumference of the body 195, and the seal ring groove 194 is disposed on the edge part 193.

The body 195 has a top surface inclined toward the water recovery hole 192.

A hook part 196 hooked to the washer body 110 is disposed on each of both sides of the body 190.

The body 195 is disposed directly above the washing container 120 to prevent the washing water from being spattered upward during the washing process.

A process for operating the automatic washer 100 according to an embodiment of the present invention is as follows.

First, a water supply hose and a water discharge hose are connected to the water supply tube 52 and the water discharge tube 54, respectively. Then, a faucet is turn on and whether a power is grounded is confirmed. Thereafter, a plug is inserted. Here, a ground terminal should not be connected to a gas tube or a water pipe. When a preparation for performing a washing process is completed, the cover 160 is opened to put vegetables and fruits to be washed into the washing container 120. If the vegetables and fruits are stained with soil, the soil should shake off before the vegetables and fruits are put into the washing container 120. If the cover 160 is not closed, operations of the devices are stopped and a buzzer is alarmed. When the cover 160 is closed, the power button 81a disposed on an upper portion of the body is pushed to apply a power. Here, when the power button 81a is pushed again one time, the power is turned off. Also, when the turn-on state has elapsed beyond five minutes, the power is automatically turned off. After the power is applied, the menu setting button 81b is pushed to set a desired menu. Then, the time setting button 81c is pushed to set a required time. Here, when the menu setting button 81b is not pushed, a standard menu is automatically set. Also, when the time setting button 81c is not pushed, a standard setting time, i.e., a time of eight minutes is automatically set. After the desired menu and time are set, the start/stop button 81d is pushed to start the washing operation for the vegetables and fruits. When the selected washing program is completed, the power is automatically turned off. Thus, when the rotation of the washing container 120 is completely stopped, the cover 160 is opened to take the vegetables and fruits out the inside of the washing container 120.

When the water supply and discharge pump 141 is forwardly operated and only the water supply valve 143 is opened during the washing process, the washing water supplied through the water supply hose is supplied into the receiving groove 110a through the water supply and discharge hole 110b within the receiving groove 110a of the body 110. As described above, the washing water is supplied, and simultaneously, the driving motor 131 of the washing container rotation module 130 is operated. Thus, the coupling 133 of the rotation shaft 132 is rotated, and also the washing container 120 engaged with the coupling is rotated. When the washing container 120 is rotated, a centrifugation operation is generated to allow the washing water to be collided against the surfaces of the vegetables and fruits, thereby washing the vegetables and fruits. During the washing process, the ozone generator 181 of the ozone supply module 180 is operated to generate ozone. The ozone having a bubble shape is transferred by an operation of the ozone pump 183 and then is supplied into the receiving groove 110a through the ozone discharge hole 110c defined in the bottom of the receiving groove 110a to sterilize the vegetables and fruits. Also, the ozone supplied into the receiving groove 110a accelerates oxidative decomposition of agricultural chemicals remaining on the vegetables or fruits together with the melting and impact using the water to remove the remaining agricultural chemicals.

As described above, when the vegetables or fruits are completely washed through the supply of the washing water, the rotation of the washing container 120, and the supply of the ozone, the water supply valve 143 is closed and the water discharge valve 145 is opened. Also, the water supply and discharge pump 141 is reversely operated.

When the water supply and discharge pump 141 is reversely operated, the water within the receiving groove 110a is discharged through the water discharge hole 110b by a suction force of the water supply and discharge pump 141. Then, the water is discharged to the outside through the discharge tube and the water discharge hose.

A negative ion generator (not shown) may be operated to obtain a negative ion effect through a process separated from the washing process or operation.

Also, the sterilization lamp 187 may be operated to sterilize the objects to be washed within the washing container 120.

The exhaust fan 113 may quickly discharge the ozone small remaining in the washer body 110 and bad small generated during the washing process.

As described above, the automatic washer of the present invention quickly may wash a large amount of vegetables or fruits to save people and time required for washing. In addition, the agricultural chemicals remaining on the vegetables or fruits may be effectively removed using the ozone. Also, the germs, microorganisms, or parasites may be sterilized using the sterilization lamp.

Also, the deodorization tube communicating with the discharge part cover may be disposed in the washer body, and the exhaust fan may be disposed within the deodorization tube to quickly discharge the ozone small and bad small generated during the washing.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An automatic washer comprising:
a washer body (110) having a receiving groove (110a);
a washing container (120) rotatably disposed in the receiving groove (110a) to contain vegetables or fruits therein;
a washing container rotation module (130) disposed on the washer body (110) to rotate the washing container (120);
a water supply and discharge module (140) disposed on the washer body (110) to control supply and discharge of washing water;
a control module (150) disposed on the washer body (110) to control operations of the washing container rotation module (130) and the water supply and discharge module (140);
a cover openably disposed on the washer body (110), the cover comprising a rib (161) on an inner surface thereof; and
a power supply module (170) supplying a power into the washing container rotation module (130) and the water supply and discharge module (140).

2. The automatic washer of claim 1, wherein the washing container rotation module (130) comprises:
a driving motor (131) generating a power;
a rotation shaft (132) passing through a center of a bottom of the receiving groove (110a) of the washer body (110) and coupled to the driving motor (131); and
a coupling (133) coupled to the rotation shaft (132) and engaged with a bottom surface of the washing container (120).

3. The automatic washer of claim 2, wherein an insertion groove (121) in which the coupling (133) is inserted is defined in the bottom surface of the washing container (120), a plurality of fixing protrusions (134) spaced a predetermined distance from each other are disposed on an outer circumference surface of the coupling (133), and hook protrusions (122) respectively inserted between the fixing protrusions (134) are disposed on an inner surface of the insertion groove (121).

4. The automatic washer of claim 3, wherein each of the fixing protrusions (134) and each of the hook protrusions (122) have inclined surfaces (134a and 122a).

5. The automatic washer of claim 1, wherein the water supply and discharge module (140) comprises:
a water supply and discharge pump (141) disposed on a lower portion of the washer body (110) to supply or discharge the washing water;
a water supply valve (143) connected to the water supply and discharge pump (141) to control the water supply; and
a water discharge valve (145) connected to the water supply and discharge pump (141) to control the water discharge.

6. The automatic washer of claim 1, wherein the water discharge valve (145) comprises a release valve.

7. The automatic washer of claim 1, further comprising an ozone supply module (180) generating ozone, the ozone supply module (180) being disposed at a lower portion of the washer body (110) to supply the ozone into the receiving groove (110a).

8. The automatic washer of claim 7, wherein the ozone supply module (180) comprises:
an ozone generator (181) generating the ozone by the control module (150);
an ozone pipe (182) connecting the ozone generator (181) to an ozone discharge hole (110c) defined in the bottom of the receiving groove (110a); and
an ozone pump (183) pumping the ozone generated in the ozone generator (181).

9. The automatic washer of claim 1, wherein an ozone discharge part (162) having a cylindrical shape and a first ozone discharge hole (161a) for discharging ozone within the receiving groove (110a) to the outside is disposed on a central portion of the cover (160), a deodorization filter (163) for filtering ozone small is disposed within the ozone discharge part (162), and a discharge part cover (165) having a second ozone discharge hole (164) is coupled to a lower portion of the ozone discharge part (162).

10. The automatic washer of claim 1, wherein a deodorization tube (111) communicating with the discharge part cover (165) is disposed in the washer body (110), and an exhaust fan (113) is disposed within the deodorization tube (111).

11. The automatic washer of claim 1, wherein the rib (161) allows water drops scattered during the rotation of the washing container (160) to drop into the washing container (120) after the water drops are collided against an under surface of the cover (160), but do not flow along a wall of the receiving groove (110a).

12. The automatic washer of claim 1, further comprising a sterilization lamp (187) disposed on a sidewall of the washer body (110) to radiate light into the washing container (120), thereby sterilizing an object to be washed within the washing container (120).

13. The automatic washer of claim 1, wherein the washing container (120) comprises a vegetable and fruit washing container for washing the vegetables and fruits and a rice washing container for washing rice,
the vegetable and fruit washing container and the rice washing container have a plurality of fine holes in bottom surfaces and side surfaces thereof to smoothly discharge the washing water, and
a wire net is disposed on an edge of an upper portion of the rice washing container (120).

14. The automatic washer of claim 1, wherein the cover (130) is elastically opened or closed by a torsion spring (not shown) disposed on a hinge (115) of the washer body (110), a locking protrusion (116) of the cover (130) is locked into a locking groove (117) of the cover (130), and a rocking release button (118) for releasing the locking of the locking protrusion (116) is disposed on the washer body (110).

15. The automatic washer of claim 1, further comprising:
a circular-shaped body (195) in which water rolling-down inclined parts (191) protruding upward with a predetermined distance are disposed on an outer portion thereof, a water recovery hole (192) for recovering the water remaining on an outer side surface of the cover (160) into the receiving groove (110a) is disposed between the water rolling-down inclined parts (191), an edge part (193) protrudes upward from an outer circumference thereof, and the seal ring groove (194) is disposed on the edge part (193); and
a seal ring (197) inserted into a seal ring groove (194).

16. The automatic washer of claim 15, wherein the body (195) has a top surface inclined toward the water recovery hole (192).

17. The automatic washer of claim 15, wherein a hook part (196) hooked to the washer body (110) is disposed on each of both sides of the edge part (193) of the body (190).

18. The automatic washer of claim 15, wherein the body (195) is disposed directly above the washing container (120) to prevent the washing water from being spattered upward during a washing process.
